(19) United States
(12) Patent Application Publication
(10) Pub. No.: US 2011/0119969 A1
(43) Pub. Date: May 26, 2011

(54) Safety Device and Method of Encouraging Safe Work Practices

(76) Inventor: David Goodley, Western Australia (AU)

(21) Appl. No.: 12/996,179

(22) PCT Filed: Jun. 5, 2009
(86) PCT No.: PCT/AU09/00718

§ 371 Date: Jan. 31, 2011

(30) Foreign Application Priority Data
Jun. 6, 2008 (AU) 2008902866

(51) Int. Cl. G09F 3/10; G09F 3/00; G09F 19/00; A42B 1/24

(52) U.S. Cl. 40/329

(57) ABSTRACT

The safety device 10 is in the form of a rectangular sheet of stiff plastic material including a display surface 12 which can be printed upon to display information 14 to remind a worker of their home life. The information may include a photograph 18 of a family member, along with a message 16 from the family member, such as “Work Safe Please Dad”. In use in a typical work-site environment, the device 10 may be affixed to the inside of a worker's safety hat such that the information 14 is readily available to provide workers with a link reminding them of their home life. Thus, the information may be readily utilised to provide a compelling reason for the workers to remain mindful of workplace safety issues.

### TECHNICAL FIELD

The present invention relates to a safety device and method of using that device to encourage safe work practices.

### BACKGROUND TO THE INVENTION

Safety in the workplace is of the utmost importance to safeguard the health and wellbeing of workers. This is particularly the case where the work involved is of a heavy nature such as in the mining, drilling and construction industries.

To date, various safety practices have been employed with various degrees of effectiveness. No single safety system can be guaranteed to be 100% effective. Therefore there remains a need for further safety measures that have the potential to further reduce the risk of accidents and injuries in the workplace, or at least to provide a useful alternative or addition to the current approaches.

### SUMMARY OF THE INVENTION

In a first aspect the present invention provides a safety device including: a display surface which displays information to remind a worker of their home life; and means for affixing the device to an item of work equipment.

The means for affixing may include a self adhesive surface.

The displayed information may include a photograph of a family member of the worker.

The displayed information may include a message from a family member of the worker.

In a second aspect the present invention provides a method of encouraging safe work practices including the steps of: issuing a number of devices according to the first aspect of the invention to a number of workers; directing the workers to affix the device to an item of their work equipment; and drawing a worker's attention to their device at a time when the worker is being instructed in safe work practices.

The item of work equipment may include a safety hat. The workers may be directed to affix the device to the inside of the safety hat. Preferably the workers are directed to affix the device such that the information is viewable in an upright orientation when the safety hat is inverted

### BRIEF DESCRIPTION OF THE DRAWINGS

An embodiment of the present invention will now be described, by way of example only, with reference to the accompanying drawings, in which:

FIG. 1 depicts a safety device according to an embodiment of the invention; and

FIG. 2 depicts the safety device affixed to the inside of a safety hat.

### DETAILED DESCRIPTION OF THE PREFERRED EMBODIMENT

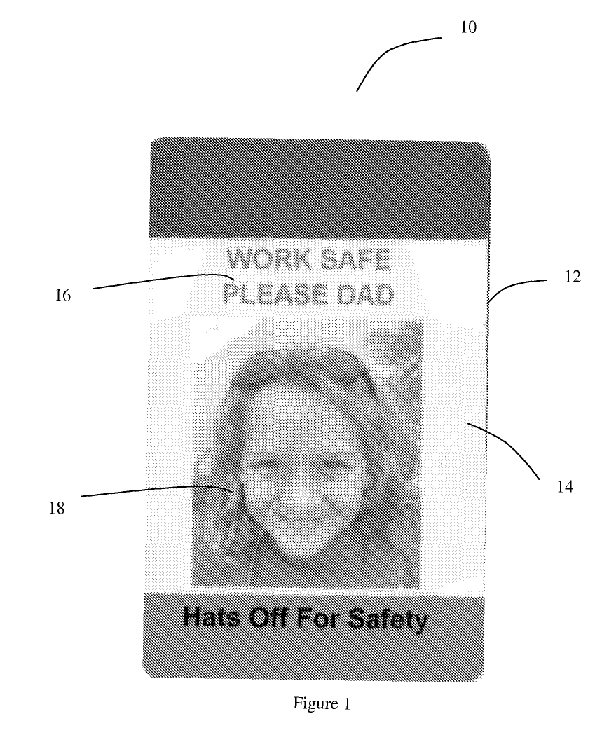

Referring to FIG. 1, a safety device 10 is shown in the form of a rectangular sheet of stiff plastic material measuring approximately 55 mm by 85 mm. The device 10 includes a display surface 12 which can be printed upon to display information 14 to remind a worker of their home life including a photograph 18 of a family member, in this case their daughter, along with a message 16 from the family member. In the illustrated embodiment the message 16 is “Work Safe Please Dad”.

The rear side of the device 10 has a self adhesive surface covered by a peel off layer. The front side of the device may also feature a corporate logo relating to the company which is implementing the scheme.

The device 10 is employed in a safety program to encourage safe work practices as follows:

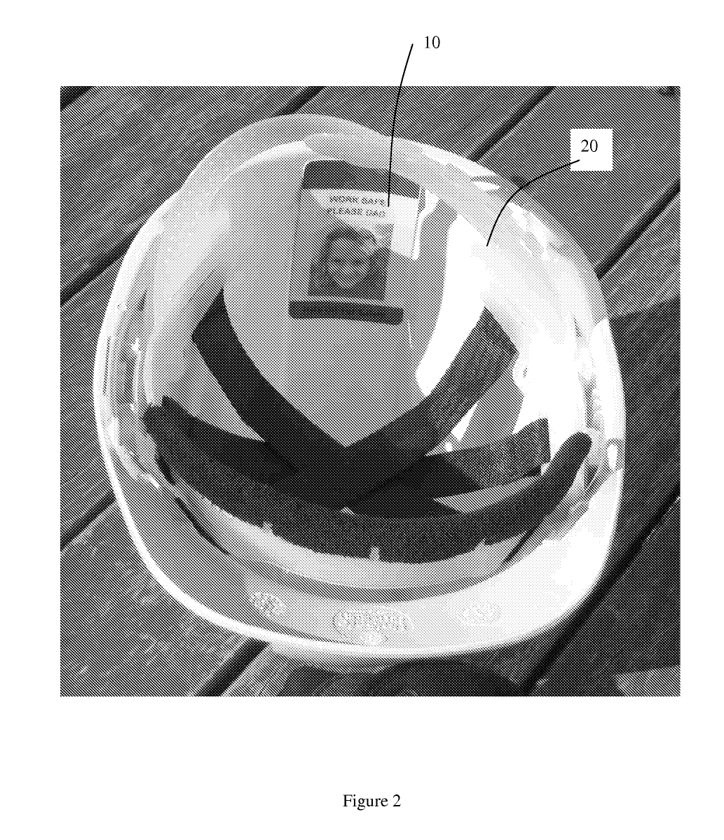

A Safety Office at a workplace orders a printer with software complete with a number of pre-cut cards 10 that can have a photograph and message imposed thereupon at site.
The Safety Officer then asks each worker for a suitable photo, which may be sent via email or downloaded from a mobile phone, for example. This photo is then printed onto the sticker along with a message and the original photo is deleted from the Safety Officer's file to help protect the employee's privacy.
The employee is then directed to place the stickers inside their locker and inside the back of their safety hat 20 such that the information is viewable in an upright orientation when the safety hat is inverted, as shown for example in FIG. 2.
Prior to any job commencing a J.S.A. (job safety analysis) is signed by all parties in the usual manner and a verbal toolbox safety meeting is held. At the end of the meeting the Chair draws the workers' attention to the safety device 10 such as by saying to all those in attendance ‘Let's now take our hats off for safety’. The workers then invert their safety hats and spend 10-15 seconds viewing the device 10 to thus remind themselves of a compelling personal reason as to why they will work safely today.
Should a worker see another behaving in a manner he deems unsafe—he may approach them and ask for his hat, look in the back and again draw attention to the safety device 10 and say words to the effect or similar—‘I wouldn't take any risks for them’.

It can be seen that embodiments of the present invention improve safety by providing workers with a link reminding them of their home life.

The present invention may be employed alongside existing safety measures to underline and improve their effectiveness in a very personal manner.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A method of encouraging safe work practices amongst a number of workers, each of the workers being respectively equipped with a safety hat, the method including the steps of:
obtaining from each of the workers information to respectively remind each of the workers of their home life;
issuing a safety device to each of the workers, whereby each safety device includes a display surface which displays the information obtained from the worker to whom the safety device has been issued and wherein each safety device includes means for affixing the device to an inside of the worker's safety hat;
directing the workers to affix the device to an inside of their safety hat; and
drawing a worker's attention to their device at a time when the worker is being instructed in safe work practices such that the information provides a reason to encourage safe work practices that is personally relevant to the worker.

2. A method according to claim 1 wherein the workers are directed to affix the device such that the information is viewable in an upright orientation when the safety hat is inverted.

3. A safety device for use in a method according to claim 1 or 2 the safety device including:
a display surface which displays information to remind a worker of their home life; and
means for affixing the device to an inside of the worker's safety hat.

4. A safety device according to claim 3 wherein the means for affixing includes a self adhesive surface.

5. A safety device according to either of claim 3 wherein the displayed information includes a photograph of a family member of the worker.

6. A safety device according to claim 3 wherein the displayed information includes a message from a family member of the worker.

7. A method of encouraging safe work practices amongst a number of workers, the method including the steps of:
obtaining from each of the workers information to respectively remind each of the workers of their home life;
issuing a safety hat to each of the workers, whereby each safety hat includes a display surface which displays the information obtained from the worker to whom the safety hat has been issued and wherein the display surface is disposed on an inside of each safety hat; and
drawing a worker's attention to the information displayed on the inside of their safety hat at a time when the worker is being instructed in safe work practices such that the information provides a reason to encourage safe work practices that is personally relevant to the worker.

8. A safety hat for use in a method according to claim 7, the safety hat having a display surface which displays information to remind a worker of their home life, the display surface being disposed on an inside of the hat.

9. A safety hat according to claim 8 wherein the information is viewable in an upright orientation when the safety hat is inverted.
